(19) United States
(12) Patent Application Publication
(10) Pub. No.: US 2011/0216024 A1
(43) Pub. Date: Sep. 8, 2011

(54) TOUCH PAD MODULE AND METHOD FOR CONTROLLING THE SAME

(75) Inventors: Chia-Hsin Yang, Taipei (TW); Yi-Hsou Lee, Taipei (TW); Yang-Po Chiu, Taipei (TW)

(73) Assignee: ASUSTEK COMPUTER INC., Taipei (TW)

(21) Appl. No.: 13/040,026

(22) Filed: Mar. 3, 2011

(30) Foreign Application Priority Data
Mar. 4, 2010 (TW) 099106258

(51) Int. Cl. G06F 3/041

(52) U.S. Cl. 345/173

(57) ABSTRACT

A touch pad module and a method for controlling the same are provided. The touch pad module provides a touch surface defining a primary area and a secondary area thereon. The touch pad module equips an active mode and a standby mode. The touch pad module switches to the standby mode from the active mode when a certain condition is met, for example, when the secondary area is touched, a secondary detecting signal is not outputted by the touch pad module.

### CROSS REFERENCE TO RELATED APPLICATIONS

This Non-provisional application claims priority under 35 U.S.C. §119(a) on Patent Application No(s). 099106258 filed in Taiwan, Republic of China on Mar. 4, 2010, the entire contents of which are hereby incorporated by reference.

### BACKGROUND OF THE INVENTION

1. Field of Invention

The invention relates to a touch pad module and a method for controlling the same and, more particularly, to a touch pad module of a portable electronic device and a method for controlling the same.

2. Related Art

With the development of science and technology, various electronic devices with a data processing function have wildly used. For example, a computer, a mobile phone, a digital camera, an electronic toy and other electronic devices are often used in our everyday life, and the computer is especially important in work and life. Moreover, with the advancement of the relating technology and rising of the users' requirements, the size and weight of the computer decreases greatly. For example, the desktop computer with less portability is developed to be a light and portable notebook computer, a hand-held computer and a tablet computer.

Generally, the basic input device of a desktop computer includes a keyboard and a mouse. The keyboard is used for inputting words and commands, and the mouse is used for moving the cursor on the screen, selecting and opening a menu. Moreover, the keyboard can cooperate with the mouse to improve the convenience in using the computer. Furthermore, a portable computer usually includes a track ball, a joy-stick, a touch pad or a track point to take place of the conventional external mouse and simplify the input device of the portable computer.

Taking a touch pad as an example, the touch pad is usually disposed below the keyboard, and it includes a touch body and several buttons around the touch body. The touch body provides a touch surface. The user can move a finger on the touch surface to control the cursor on the screen, and click on the touch surface to select or execute a program. The buttons are usually set to include the functions of the left button and the right button of a mouse, and thus the user can execute all the functions of a mouse via the touch pad.

However, as the size of the portable electronic device becomes smaller, the size of its keyboard and the touch pad should be reduced correspondingly, and the distance between the keyboard and the touch pad is also getting shorter. As a result, the user often touches the touch surface of the touch pad by mistake when he operates the keyboard, especially in typing, resulting in cursor moving, or even opening a menu or enabling a selecting function. At present, a part of the notebook computers may close the touch pad function via software or hardware to avoid the mistakes. However, the user may need to switch frequently to enable and disable the touch pad, and remember the current state of the touch pad, which is rather inconvenient.

### SUMMARY OF THE INVENTION

A touch pad module is provided. The touch pad module provides a touch surface, and the touch surface defines a primary area and a secondary area. The touch pad module further defines an active mode and a standby mode. When the touch pad module enters the active mode from the standby mode according to a first condition, the touch pad module does not output a secondary detecting signal corresponding to the touch on the secondary area. In other words, the touch pad module only outputs a primary detecting signal corresponding to the touch on the primary area. On the contrary, when the touch pad module enters the standby mode from the active mode according to a second condition, the touch pad module outputs the primary detecting signal and the secondary detecting signal simultaneously.

According to another aspect, a control method of the touch pad is provided. In an embodiment, the touch pad module provides a touch surface, and the touch surface defines a primary area and a secondary area. The touch pad module further defines an active mode and a standby mode. The control method in the embodiment includes the following steps: controlling the touch pad module to enter the standby mode from the active mode according to a first condition. When the touch pad module is in the standby mode, it does not output a secondary detecting signal according to the touch of the secondary area. In other words, the touch pad module only outputs a primary detecting signal according to the touch on the primary area. Furthermore, the method further includes the following steps: controlling the touch pad module to enter the active mode from the standby mode according to a second condition. When the touch pad module is in the active mode, it outputs the primary detecting signal and the secondary detecting signal.

The first condition above may be that the touch pad module receives a standby signal, or the touch surface is not touched for a preset time, which is not limited herein. Besides, the second condition above may be that the touch pad module determines whether the primary area is touched or not. If the primary area is touched, the touch pad module enters the active mode again.

In sum, the touch pad module is switchable between the standby mode and the active mode according to the first condition and the second condition. When in the active mode, the touch pad module outputs all the detecting signals; on the contrary, when in the standby mode, the touch pad module only generates or outputs the detecting signal according to the touch action on a specific area. The touch pad module and the control method determine whether the user needs to use the touch control function automatically to control the touch pad module to enter the active mode or the standby mode.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a touch pad module in a first embodiment;

FIG. 2 is a functional block diagram showing a touch pad module in a first embodiment;

FIG. 3 is a flowchart showing a control method of a touch pad module in a first embodiment;

FIG. 4 is a schematic diagram showing a touch pad module in a second embodiment;

FIG. 5 is a functional block diagram showing a touch pad module in a second embodiment; and

FIG. 6 is a flowchart showing a control method of a touch pad module in a second embodiment.

### DETAILED DESCRIPTION OF THE INVENTION

A touch pad module and a method for controlling the same are provided. The touch control device may be applied in an electronic device such as a notebook computer, a hand-held computer, a tablet computer and other media players, which is not limited herein.

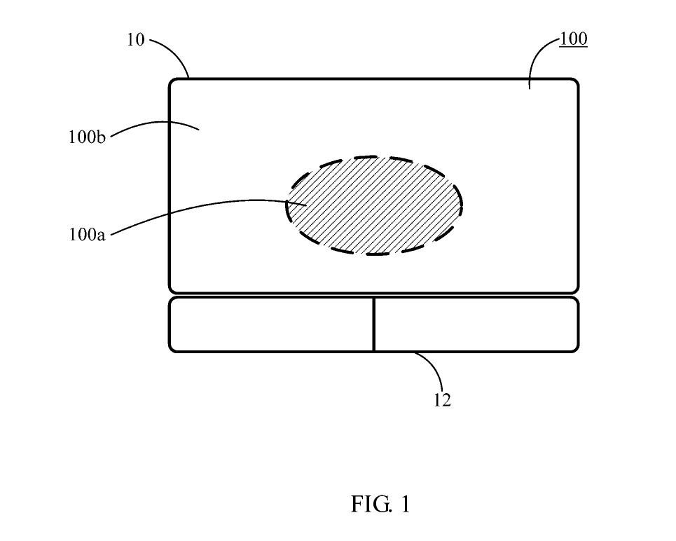

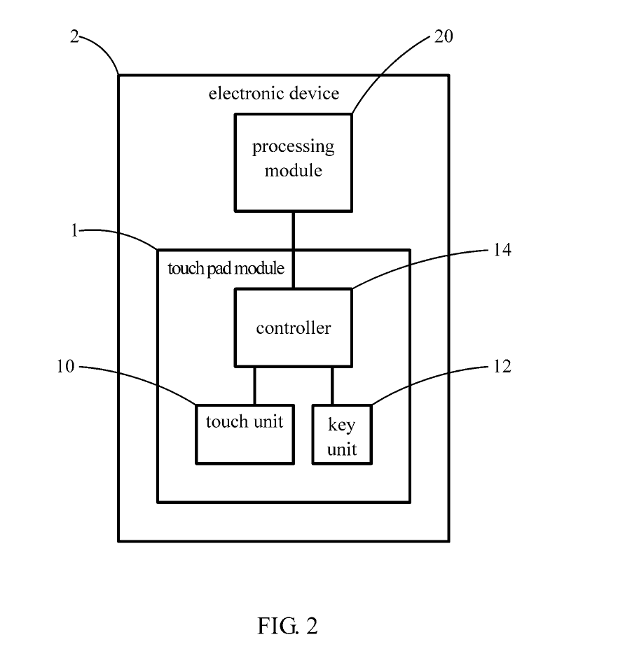

FIG. 1 is a schematic diagram showing a touch pad module in a first embodiment. FIG. 2 is a functional block diagram showing a touch pad module in a first embodiment. In the embodiment, a touch pad module 1 defines an active mode and a standby mode. As shown in FIG. 2, the touch pad module 1 in the embodiment includes a touch control unit 10, a key unit 12 and a controller 14.

The touch control unit 10 includes a touch surface 100. The touch surface 100 defines a primary area 100a, which is an ellipse area surrounded by a dotted line as shown in FIG. 1, and a secondary area 100b which is part of the touch surface 100 besides the ellipse area as shown in FIG. 1. The size and position of the primary area 100a and the secondary area 100b may be adjusted according to different touch control units 10, the specification of the electronic device using the same or other features. It also may be decided by the user. In the embodiment, the primary area 100a is about at the center of the touch surface 100, its area is smaller than that of the secondary area 100b, and the secondary area 100b surrounds the primary area 100a.

The key unit 12 is disposed under the touch control unit 10. It may cooperate with the touch control unit 10 to include the function of a mouse or other operating functions. In practical usage, the key unit 12 may be a physical button or a virtual button, and the number and position can be adjusted according to the requirement.

Besides, the controller 14 is connected with the touch control unit 10, the key unit 12 and a processing module 20 (such as a central processing unit (CPU), a micro processor or a control chip, which is not limited herein) of the electronic device 2. The controller 14 may receive a signal generated by the touch control unit 10 and the key unit 12, and transmits the signal to the processing module 20. The controller 14 also may receive the signal from the processing module 20, and controls the touch control unit 10 and the key unit 12 according to the signal.

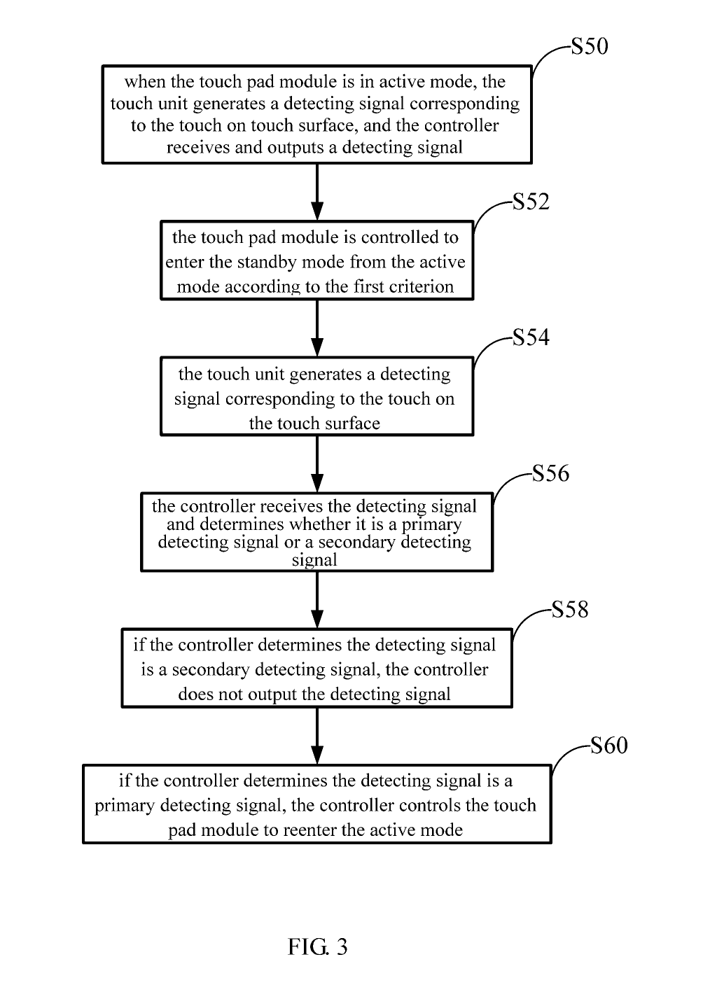

FIG. 3 is a flowchart showing a control method of a touch pad module in a first embodiment. As shown in FIG.3, the control method includes the following steps.

When the touch pad module 1 is in the active mode, it includes the complete touch control function. The touch control unit 10 generates a detecting signal corresponding to the touch action on the touch surface 100, and the controller 14 receives and outputs the detecting signal (Step S50). In practical usage, the controller 14 outputs the detecting signal to the processing module 20, and the processing module 20 executes the corresponding programs.

Then, the touch pad module 1 is controlled to enter the standby mode from the active mode according to a first condition (Step S52). The first condition is, for example, the touch pad module 1 receives a standby signal generated by the processing module 20 or other devices when the user operates the electronic device 2. Moreover, the first condition also may be that the touch surface 100 is not touched for a preset time such as 30 seconds or 1 minute, which is not limited herein. In practical usage, the first condition may also be executed when meets other conditions, for example, the keyboard is operated for some time. In practical usage, the first condition may also be other appropriate conditions, which are not limited herein.

Then, the touch control unit 10 generates the detecting signal corresponding to the touch action on the touch surface 100 (Step S54).

The controller 14 receives the detecting signal and determines whether it is a primary detecting signal or a secondary detecting signal (Step S56). In the embodiment, the primary detecting signal is the detecting signal generated according to the touch on the primary area 100a of the touch surface 100, and the secondary detecting signal is the detecting signal according to the touch on the secondary area 100b of the touch surface 100. In practical usage, the controller 14 determines the coordinate position of the touch on the touch surface 100 according to the information of the detecting signal, and determines whether the touch is on the primary area 100a or the secondary area 100b accordingly.

If the controller 14 determines the detecting signal is the secondary detecting signal, the controller 14 does not output the detecting signal (Step S58).

If the controller 14 determines the detecting signal is the primary detecting signal (meets the second condition), the controller 14 controls the touch pad module 1 to reenter the active mode (Step S60). In practical usage, when the detecting signal is the primary detecting signal, the controller 14 may selectively output the detecting signal. For example, when the detecting signal is the primary detecting signal, the controller 14 outputs the detecting signal to the processing module 20, and the processing module 20 executes the corresponding program.

The second condition includes not only the situation that the primary area is touched, but also the touching actions, such as double-click signal or specific gestures. Besides, the second condition is executed accompanying with other conditions, for example, if the keyboard or the mouse is not operated for some time, the second condition is executed. In practical usage, the second condition any conditions or the conditions set by the users, which is not limited herein.

In sum, in the embodiment, the control method and the controller control the touch pad module to be switched between the active mode and the standby mode according to appropriate conditions. When in the active mode, the touch pad module executes a common touch control program; when in the standby mode, if the user touches the secondary area of the touch surface by mistake, the touch pad module does not execute the touch control program, and only if the user touches the primary area, the touch pad module reenters the active mode to execute the touch control program.

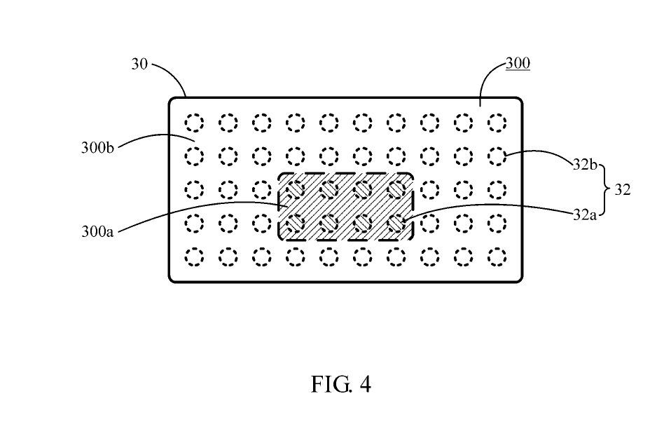

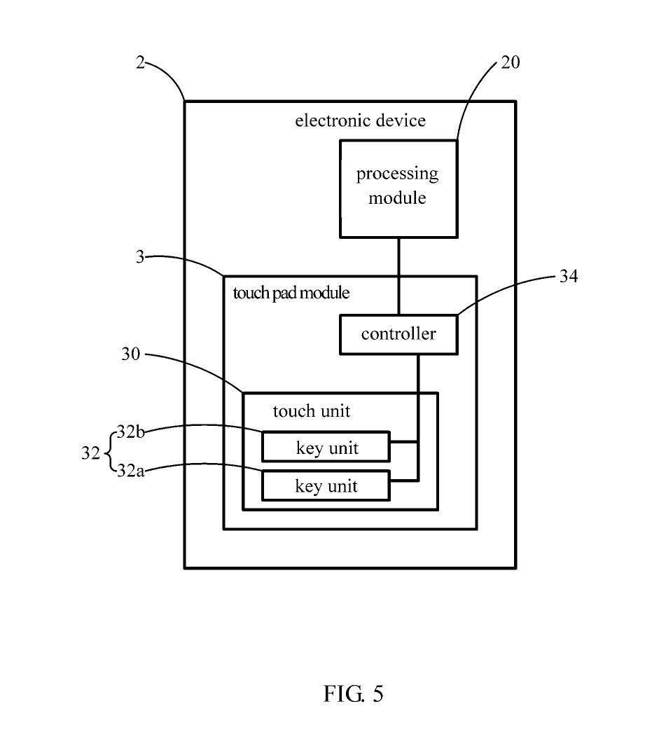

FIG. 4 is a schematic diagram showing a touch pad module in a second embodiment. FIG. 5 is a functional block diagram showing a touch pad module in a second embodiment. In the embodiment, the touch pad module 3 is defined an active mode and a standby mode. As shown in FIG. 4, the touch pad module 3 in the embodiment includes a touch control unit 30, a plurality of detecting units 32 and a controller 34. In practical usage, the touch pad module 3 in the embodiment also may include the key unit as described above.

The touch control unit 30 includes a touch surface 300 defining a primary area 300a (a rectangular area defined by the dotted line) and a secondary area 300b (outside the dotted line) thereon. The area and position of the primary area 300a and the secondary area 300b can be adjusted according to different touch control units 30, the specifications of electronic devices or depends by other features. It may also be set by the user. In an embodiment, the primary area 300a is located approximately at the center of the touch surface 300. The area of the primary area 300a is smaller than that of the secondary area 300b, and the secondary area 300b surrounds the primary area 300a.

The detecting units 32 are disposed under the touch surface 300. The detecting units 32 corresponding to the primary area 300a are set to be the first detecting units 32a, and the detecting units 32 corresponding to the secondary area 300b are set to be the second detecting units 32b. The first detecting units 32a detect the touch on the primary area 300a and generate the corresponding primary detecting signals; the second detecting units 32b detect the touch on the secondary area 300b and generate the corresponding secondary detecting signals.

Moreover, the controller 34 is connected with the detecting units 32 and the processing module 20 of the electronic device 2, respectively, to receive the primary detecting signals and the secondary detecting signals, and transmit the detecting signals to the processing module 20. The controller 14 may also receive the signal from the processing module 20, and control the detecting units 32 accordingly.

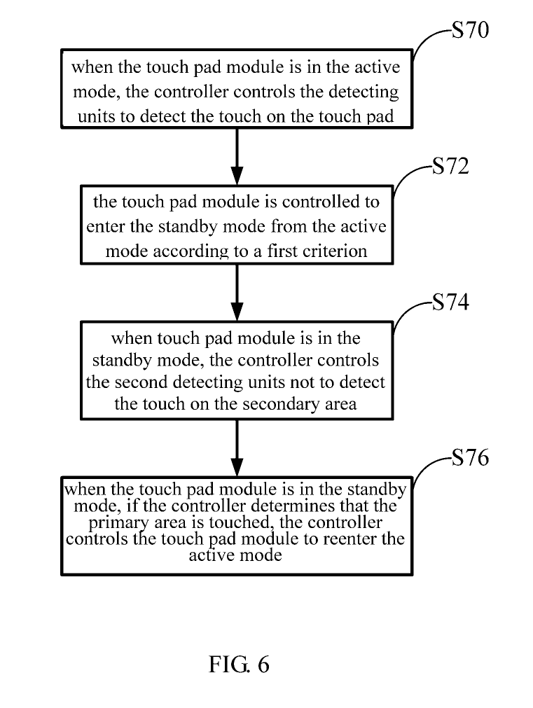

FIG. 6 is a flowchart showing a control method of a touch pad module in a second embodiment. As shown in FIG. 6, the control method includes the steps as described below.

When the touch pad module 3 is in the active mode, it equips the complete touch control function. The controller 14 controls the detecting units 32 to detect the touch on the primary area 300a and the secondary area 300b (Step S70). After the controller 14 receives the detecting signals, it transmits the detecting signals to the processing module 20, and the processing module 20 executes the corresponding programs.

Then, the touch pad module 3 is controlled to enter the standby mode from the active mode according to the first condition (Step S72). As stated above, the first condition may be that the touch pad module 3 receives a standby signal generated by the processing module 20 or other devices when the user operates the electronic device 2. Besides, the first condition also may be that the touch surface 300 is not touched for a preset time such as 30 seconds or 1 minute, which is not limited herein. In practical usage, the first condition may also be executed in conditions, for example, while the keyboard is operated for some time. In practical usage, the first condition may also be other appropriate conditions and made by the user, which is not limited herein.

When the touch pad module 3 is in the standby mode, the controller 34 controls the second detecting units 32b not to detect the touch action on the secondary area 300b (Step S74). In other words, the controller 34 closes the second detecting units 32b.

When the touch pad module 3 is in the standby mode, if the controller 34 determines that the primary area 300a is touched (meeting the second condition), the controller 14 controls the touch pad module 3 to reenter the active mode (Step S76).

The second condition may not only include that the primary area is touched, but also the touch mode such as a double-click touch or some special gestures. Besides, the second condition may also be executed in other conditions, for example, while the keyboard or the mouse is not operated for some time. In practical usage, the second condition may be other conditions or under any settings that made by users, which is not limited herein.

In sum, in the embodiment, the control method and the controller may control the touch pad module to switch between the active mode and the standby mode according to appropriate conditions. When in the active mode, the touch pad module executes a common touch control program; when in the standby mode, if the user touches the secondary area of the touch surface by mistake, the touch pad module does not execute the touch control program, and only if the user touches the primary area, the touch pad module reenters the active mode to execute the touch control program.

In conclusion, the touch pad module can be switched between the standby mode and the active mode according to the first condition and the second condition. When in the active mode, the touch pad module outputs all the detecting signals corresponding to the touch actions and executes the touch control program as determined. On the contrary, when in the standby mode, the touch pad module only generates or outputs the detecting signal corresponding to the touch actions on the specific area. As a result, the touch pad module and the control method automatically determines whether the user needs to use the touch control function, and can be switched the touch pad module to the active mode or the standby mode.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A touch pad module comprising:
a touch surface including a primary area and a secondary area,
wherein when a first condition is met, the touch pad module switches from an active mode to a standby mode, and the touch pad module has no response.

2. The touch pad module according to claim 1, wherein no reactions of the touch pad module includes no outputs of a secondary detecting signal corresponding to a touch action on the secondary area of the touch pad module.

3. The touch pad module according to claim 1, wherein the first condition includes that the touch pad module receives a standby signal.

4. The touch pad module according to claim 1, wherein the first condition includes that the touch surface is not touched for a preset time.

5. The touch pad module according to claim 1, wherein the touch pad module further comprises:
a plurality of first detecting units disposed under the touch surface corresponding to the primary area for detecting a touch action on the primary area; and
a plurality of second detecting units disposed under the touch surface corresponding to the secondary area,
when the touch pad module is in the active mode, the second detecting units detects the touch actions on the secondary area; and when the touch pad module is in the standby mode, the second detecting units has no response to the touch actions on the secondary area.

6. The touch pad module according to claim 1, wherein the touch pad module further comprises:
a touch control unit including the touch surface and generating a detecting signal corresponding to a touch action on the touch surface; and
a controller connected with the touch control unit for receiving and determining whether the detecting signal is the secondary detecting signal;
when the touch pad module is in the standby mode and the controller determines that the detecting signal is the secondary detecting signal, the controller does not output the detecting signal.

7. The touch pad module according to claim 1, wherein the primary area is at a center of the touch surface.

8. The touch pad module according to claim 6, wherein the secondary area surrounds the primary area.

9. The touch pad module according to claim 2, wherein when the touch pad module meets a second condition, the standby mode switches to the active mode, and in the active mode, the touch pad module outputs the secondary detecting signal corresponding to the touch actions on the secondary area.

10. The touch pad module according to claim 8, wherein the second condition includes that the touch pad module determines whether the primary area is touched or not, and if the primary area is touched, the touch pad module reenters the active mode.

11. A control method of the touch pad module, wherein the touch pad module has a touch surface with a primary area and a secondary area defined thereon, and the touch pad module equips an active mode and a standby mode, the method comprising:
controlling the touch pad module to switch to the standby mode from the active mode when a first condition is met; and
when the touch pad module is in the standby mode, no secondary detecting signal corresponding to a touch action on the secondary area is outputted.

12. The control method according to claim 11, wherein the first condition includes that the touch pad module receives a standby signal.

13. The control method according to claim 11, wherein the first condition includes that the touch surface is not touched for a preset time.

14. The control method according to claim 11, wherein the touch pad module further comprises a plurality of first detecting units disposed under the touch surface corresponding to the primary area, and a plurality of second detecting units disposed under the touch surface corresponding to the secondary area, and the control method further includes:
controlling the first detecting units to detect the touch action on the primary area and generating a corresponding primary detecting signal;
controlling the second detecting units to detect the touch action on the secondary area and generating the corresponding secondary detecting signal when the touch pad module is in the active mode; and
controlling the second detecting units to stop detecting the touch on the secondary area when the touch pad module is in the standby mode.

15. The control method according to claim 11, wherein the touch pad module further includes a touch control unit with the touch surface, and the control method further comprises:
controlling the touch control unit to generate a detecting signal according to the touch action on the touch surface;
receiving the detecting signal and determining whether the detecting signal is the secondary detecting signal; and
when the touch pad module is in the standby mode and the detecting signal is the secondary detecting signal, no detecting signal is outputted.

16. The control method according to claim 11, wherein the primary area is at the center of the touch surface.

17. The control method according to claim 16, wherein the secondary area surrounds the primary area.

18. The control method according to claim 11, further comprises:
controlling the touch pad module to enter the active mode from the standby mode when to a secondary condition is met; and
outputting the secondary detecting signal corresponding to the touch on the secondary area when in the active mode.

19. The control method according to claim 18, wherein the second condition includes that the touch pad module determines whether the primary area is touched or not, and if the primary area is touched, the touch pad module is controlled to enter the active mode.
